(19) United States
(12) Patent Application Publication
(10) Pub. No.: US 2019/0279644 A1
(43) Pub. Date: Sep. 12, 2019

(54) SPEECH PROCESSING DEVICE, SPEECH PROCESSING METHOD, AND RECORDING MEDIUM

(71) Applicant: NEC CORPORATION, Tokyo (JP)

(72) Inventors: Hitoshi YAMAMOTO, Tokyo (JP); Takafumi KOSHINAKA, Tokyo (JP); Takayuki SUZUKI, Tokyo (JP)

(73) Assignee: NEC CORPORATION, Tokyo (JP)

(21) Appl. No.: 16/333,008

(22) PCT Filed: Sep. 11, 2017
(86) PCT No.: PCT/JP2017/032666

§ 371 Date: Mar. 13, 2019

(30) Foreign Application Priority Data
Sep. 14, 2016 (JP) 2016-179123

(51) Int. Cl. G10L 17/02; G10L 17/12

(52) U.S. Cl. CPC G10L 17/02; G10L 17/12

(57) ABSTRACT

A speech processing device includes at least one memory configured to store instructions and at least one processor configured to execute the instructions to: store one or more acoustic models; calculate an acoustic feature from a received speech signal, and by using the acoustic feature calculated and the acoustic model stored, calculate an acoustic diversity that is a vector representing a degree of variations of types of sounds; by using the calculated acoustic diversity and a selection coefficient, calculate a weighted acoustic diversity, and by using the weighted acoustic diversity calculated and the acoustic feature, calculate a recognition feature for recognizing identity of a speaker that concerns the speech signal; and calculate a feature vector by using the recognition feature calculated.

### TECHNICAL FIELD

The present disclosure relates to speech processing, and particularly relates to a speech processing device, a speech processing method, and the like that recognize, from a speech signal, attribute information such as individuality or an uttered language of a speaker.

### BACKGROUND ART

There is known a speech processing device that extracts, from a speech signal, an acoustic feature (individuality feature) representing individuality for identifying a speaker who has uttered speech, and an acoustic feature representing a language communicated by the speech. As one type of the speech processing device, there are known a speaker recognition device for estimating a speaker by using the acoustic features included in a speech signal, and a language recognition device for estimating a language.

The speaker recognition device using the speech processing device evaluates a similarity between an individuality feature extracted from a speech signal by the speech processing device and a predefined individuality feature, and selects a speaker, based on the evaluation. For example, the speaker recognition device selects a speaker identified by an individuality feature that is evaluated as having the highest similarity.

NPL 1 describes a technique of extracting an individuality feature from a speech signal input to a speaker recognition device. For the speech signal, the feature extraction technique described in NPL 1 calculates an acoustic statistic of the speech signal by using an acoustic model, processes the acoustic statistic, based on a factor analysis technique, and thereby expresses any speech signal in a form of a vector having a predetermined number of elements. Further, the speaker recognition device uses the feature vector as the individuality feature of the speaker.

### CITATION LIST

### Patent Literature

[PTL 1] International Publication No. WO2014/155652

### Non Patent Literature

[NPL 1] Najim Dehak, Patrick Kenny, Reda Dehak, Pierre Dumouchel, and Pierre Ouellet, “Front-End Factor Analysis for Speaker Verification”, IEEE Transactions on Audio, Speech and Language Processing, Vol. 19, No. 4, pp. 788-798, 2011.

### SUMMARY OF INVENTION

### Technical Problem

For the speech signal input to the speaker recognition device, the technique described in NPL 1 compresses, based on the factor analysis technique, the acoustic statistic calculated by using the acoustic model. However, this technique merely calculates one feature vector by uniform statistical processing on the entire speech signal input to the speaker recognition device.

Accordingly, the technique described in NPL 1 can calculate a score (points) based on a similarity of the feature vector in speaker recognition calculation. However, it is difficult for the technique described in NPL 1 to analyze and interpret an association relation between each element in the feature vector and a speech signal, or to analyze and interpret an influence given, to a speaker recognition result, by each element in the feature vector.

The present disclosure has been made in view of the above-described problem, and an object thereof is to provide a technique for enhancing interpretability of a speaker recognition result.

### Solution to Problem

A speech processing device according to the present disclosure includes: acoustic model storage means for storing one or more acoustic models; acoustic statistic calculation means for calculating an acoustic feature from a received speech signal, and by using the acoustic feature calculated and the acoustic model stored, calculating an acoustic diversity that is a vector representing a degree of variations of types of sounds; partial feature extraction means for, by using the calculated acoustic diversity and a selection coefficient, calculating a weighted acoustic diversity, and by using the weighted acoustic diversity calculated and the acoustic feature, calculating a recognition feature for recognizing individuality or a language of a speaker that concerns the speech signal; and partial feature integration means for calculating a feature vector by using the recognition feature calculated.

A speech processing method according to the present disclosure includes: storing one or more acoustic models; calculating an acoustic feature from a received speech signal, and by using the acoustic feature calculated and the acoustic model stored, calculating an acoustic diversity that is a vector representing a degree of variations of types of sounds; by using the calculated acoustic diversity and a selection coefficient, calculating a weighted acoustic diversity; by using the weighted acoustic diversity calculated and the acoustic feature, calculating a recognition feature that is information for recognizing information indicating individuality, a language, or the like of a speaker; and calculating a feature vector by using the recognition feature calculated.

A recording medium that stores a program for causing a computer to function as: means for storing one or more acoustic models; means for calculating an acoustic feature from a received speech signal, and by using the acoustic feature calculated and the acoustic model stored, calculating an acoustic diversity that is a vector representing a degree of variations of types of sounds; and means for, by using the calculated acoustic diversity and a selection coefficient, calculating a weighted acoustic diversity, and by using the weighted acoustic diversity calculated and the acoustic feature, calculating a recognition feature that is information for recognizing information indicating individuality, a language, or the like of a speaker.

### Advantageous Effects of Invention

According to the present disclosure, it is possible to provide a technique for enhancing interpretability of a speaker recognition result.

### BRIEF DESCRIPTION OF DRAWINGS

FIG. 1 is a block diagram of a speech processing device according to a first example embodiment.

FIG. 2 is a flowchart illustrating one example of an operation of the speech processing device according to the first example embodiment.

FIG. 3A is a diagram illustrating one example of a configuration of a partial feature extraction unit of the speech processing device according to the first example embodiment.

FIG. 3B exemplifies an acoustic diversity according to the first example embodiment.

FIG. 3C exemplifies a selection coefficient Wn according to the first example embodiment.

FIG. 3D exemplifies a selection coefficient Wn according to the first example embodiment FIG. 4 is a block diagram illustrating one example of a functional configuration of a speaker recognition device according to a second example embodiment.

FIG. 5 is a flowchart illustrating one example of an operation of the speaker recognition device according to the second example embodiment.

FIG. 6 is a diagram illustrating one example of a configuration of a speaker recognition calculation unit of the speaker recognition device according to the second example embodiment.

FIG. 7A is a diagram illustrating one example of a speaker recognition result output by the speaker recognition device according to the second example embodiment.

FIG. 7B is a diagram illustrating one example of a speaker recognition result output by the speaker recognition device according to the second example embodiment.

FIG. 7C is a diagram illustrating one example of a speaker recognition result output by the speaker recognition device according to the second example embodiment.

### EXAMPLE EMBODIMENT

Hereinafter, example embodiments of the present disclosure are described in detail with reference to the drawings. Note that in the following description, the same reference symbols are attached to constituent elements having the same functions, and the description thereof is omitted in some cases.

Configuration

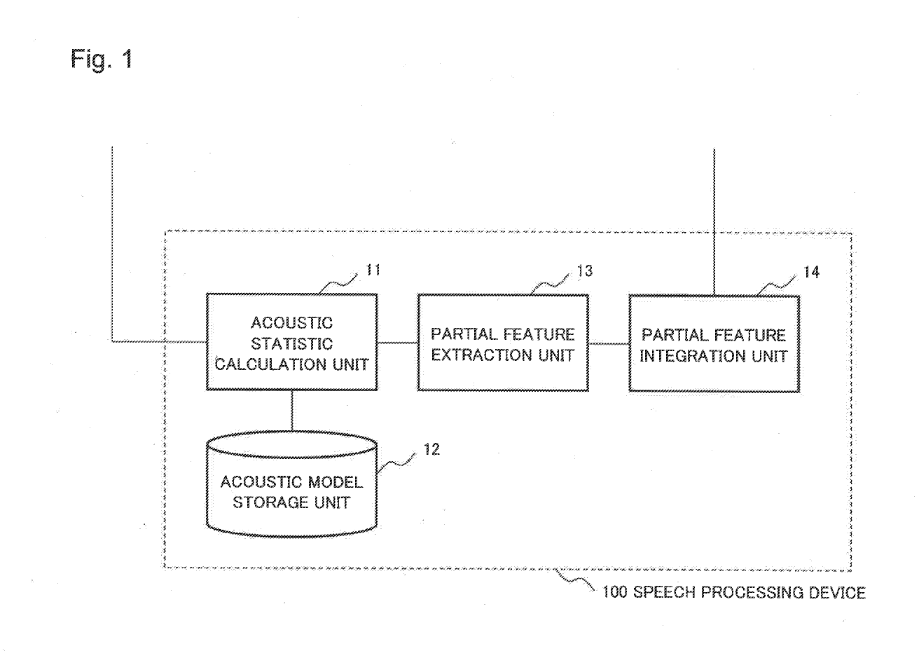

FIG. 1 is a block diagram of a speech processing device 100 according to a first example embodiment. The speech processing device 100 includes an acoustic statistic calculation unit 11, an acoustic model storage unit 12, a partial feature extraction unit 13, and a partial feature integration unit 14.

Acoustic Model Storage Unit 12

The acoustic model storage unit 12 stores one or more acoustic models. The acoustic model represents an association relation between a frequency characteristic of a speech signal and a kind of sounds. The acoustic model is configured for identifying a type of sounds represented by an instantaneous speech signal. Examples of representation of an acoustic model include a Gaussian mixture model (GMM), a neural network, and a hidden Markov model (HMM).

An example of a type of sounds is a cluster of speech signals acquired by clustering speech signals, based on a similarity. Alternatively, a type of sounds is a class of speech signals classified based on language knowledge such as phonemes.

The acoustic model stored in the acoustic model storage unit 12 is an acoustic model trained previously in accordance with a general optimization criterion by using speech signals (training speech signals) prepared for training. The acoustic model storage unit 12 may store two or more acoustic models trained for each of a plurality of training speech signals, e.g., for each of sexes (a male and a female) of a speaker, for each of recording environments (indoor and outdoor), or the like.

Note that in the example of FIG. 1, the speech processing device 100 includes the acoustic model storage unit 12, but the acoustic model storage unit 12 may be implemented by a storage device separate from the speech processing device 100.

Acoustic Statistic Calculation Unit 11

The acoustic statistic calculation unit 11 receives a speech signal, calculates an acoustic feature from the received speech signal, and calculate an acoustic diversity by using the acoustic feature calculated and one or more acoustic models, and outputs the acoustic diversity calculated and acoustic feature.

Here, “receives” means reception of a speech signal from an external device or another processing device, or reception of delivery of a processed result from another program, for example. The acoustic diversity is a vector representing a degree of variations of types of sounds included in a speech signal. Hereinafter, the acoustic diversity calculated from a certain speech signal is referred to as an acoustic diversity of the speech signal. In addition, “outputs” means transmission to an external device or another processing device, or delivery of the processed result to another program, for example. Further, “outputs” is a notion that includes displaying on a display, projection using a projector, printing by a printer, and the like.

First, the description is made on a procedure in which the acoustic statistic calculation unit 11 calculates an acoustic feature by performing a frequency analysis process on a received speech signal.

The acoustic statistic calculation unit 11 cuts out, to make frames, the received speech signal at short time span, and arranges the cut-out frames in a time series (time series short-time-frames), performs frequency analysis on each of the frames, and calculates an acoustic feature as a result of the frequency analysis. With regard to the time series short-time-frame, the acoustic statistic calculation unit 11 arranges each frame of a 25-millisecond section with 10-millisecond time span, for example.

The acoustic statistic calculation unit 11 performs, as the frequency analysis process, fast Fourier transform (FFT) and a filter bank process, for example, and thereby calculates a frequency filter bank characteristic as an acoustic feature. Alternatively, the acoustic statistic calculation unit 11 performs, as the frequency analysis process, a discrete cosine transform process as well as the FFT and the filter bank process, and thereby calculates Mel-Frequency Cepstrum coefficients (MFCC) as an acoustic feature.

The above is the procedure in which the acoustic statistic calculation unit 11 calculates the acoustic feature by performing the frequency analysis process on a received speech signal.

Next, the description is made on a procedure in which the acoustic statistic calculation unit 11 calculates an acoustic diversity by using an acoustic feature calculated and one or more acoustic models stored in the acoustic model storage unit 12.

For example, when the acoustic model to be used is a GMM, a plurality of element distributions included in the GMM are in association with different types of sounds, respectively. Accordingly, the acoustic statistic calculation unit 11 extracts, from the acoustic model (GMM), parameters (a mean and variance) of each of a plurality of the element distributions and a mixed coefficient of each of the element distributions, and calculates an appearance degree of each of the types of sounds included in the speech signal, based on the acoustic feature calculated, the extracted parameters (the mean and the variance) of the element distributions, and the extracted mixed coefficients of the respective element distributions. Here, the appearance degree means a degree (appearance frequency) at which an appearance occurs, or probability of an appearance. Thus, the appearance degree is a natural number (appearance frequency) in one case, or is a decimal (probability) equal to or larger than zero and smaller than one in another case.

Further, for example, when the acoustic model to be used is a neural network, respective elements of an output layer included in the neural network are in association with different types of sounds, respectively. Accordingly, the acoustic statistic calculation unit 11 extracts parameters (a weighting coefficient and a bias coefficient) of each of elements from the acoustic model (neural network), and calculates an appearance degree of each of the types of sounds included in the speech signal, based on the acoustic feature calculated and the extracted parameters (the weighting coefficient and the bias coefficient) of the elements. By using the thus-calculated appearance degree of each of a plurality of the types of sounds, the acoustic statistic calculation unit 11 further calculates an acoustic diversity.

The above is the procedure in which the acoustic statistic calculation unit 11 calculates an acoustic diversity by using the acoustic feature calculated and one or more acoustic models stored in the acoustic model storage unit 12.

Next, the detailed description is made on one example of a procedure in which the acoustic statistic calculation unit 11 calculates an acoustic diversity V(x) of a speech signal x.

For example, when the acoustic model to be used is a GMM, the acoustic statistic calculation unit 11 first generates, for a speech signal x, posterior probability for each of a plurality of element distributions included in the GMM that is an acoustic model. The posterior probability Pᵢ(x) for the i-th element distribution of the GMM represents a degree at which the speech signal x belongs to the i-th element distribution of the GMM. By the following equation 1, Pᵢ(x) is acquired.

$${P}_{i} ( x ) = \frac{{w}_{i} N ( x \vert {θ}_{i} )}{{\sum }_{j} {w}_{j} N ( x \vert {θ}_{j} )} \qquad [ Equation 1 ]$$

Here, the function N( ) represents a probability density function of the Gaussian distribution, θᵢ indicates parameters (a mean and variance) of the i-th element distribution of the GMM, and wᵢ indicates the mixing coefficient of the i-th element distribution of the GMM. Next, the acoustic statistic calculation unit 11 calculates the acoustic diversity V(x) that is a vector including Pᵢ(x) as the element. For example, when the mixing number in the GMM that is an acoustic model is four, “V(x)=[P₁(x), P₂(x), P₃(x), P₄(x)]” is given.

The above is one example of the procedure in which the acoustic statistic quantity calculation unit 11 calculates the acoustic diversity V(x) of a speech signal x.

Next, the detailed description is made on another method in which the acoustic statistic calculation unit 11 calculates an acoustic diversity V(x) of a speech signal x.

For example, when the acoustic model to be used is a GMM, the acoustic statistic calculation unit 11 divides a speech signal x into a time series of short-time speech signals {x1, x2, . . . , xT} (T is an arbitrary natural number). Then, the acoustic statistic calculation unit 11 acquires, for each of the short-time speech signals, the element distribution number i at which the appearance probability becomes the maximum, by the following equation 2.

Argmax_i(xt)=N(xt|θᵢ) [Equation 2]

Here, the number of times the i-th element distribution in the GMM is selected is assumed to be Cᵢ(x). The symbol Cᵢ(x) represents a degree at which the speech signal x belongs to the i-th element distribution in the GMM. Next, the acoustic statistic calculation unit 11 calculates an acoustic diversity V(x) as a vector including Cᵢ(x) or Cᵢ(x)/ΣⱼCⱼ(x) as the element. For example, when the mixing number in the GMM that is an acoustic model is four, the acoustic diversity becomes to be “V(x)=[C₁(x), C₂(x), C₃(x), C₄(x)]”.

Note that the acoustic statistic calculation unit 11 may calculate an acoustic diversity after segmenting a received speech signal. More specifically, for example, the acoustic statistic calculation unit 11 may segment a received speech signal at constant time span into segmented speech signals, and calculate an acoustic diversity for each of the segmented speech signals.

Alternatively, when duration of a speech signal exceeds a predetermined value while the acoustic statistics calculation unit 11 is receiving the speech signal from an external device or another processing device, the acoustic statistic calculation unit 11 calculates an acoustic diversity of the speech signal received until that point of time. Further, when referring to two or more acoustic models stored in the acoustic model storage unit 12, the acoustic statistic calculation unit 11 may calculate an appearance degree, based on each of the acoustic models. Then, the acoustic statistic calculation unit 11 may calculate an acoustic diversity by using the appearance degree that is calculated based on each of two or more acoustic models, may weight the calculated acoustic diversities, and may generate, as a new acoustic diversity, the sum of the weighted acoustic diversities.

The above is another method in which the acoustic statistic amount calculation unit 11 calculates an acoustic diversity V(x) of a speech signal x.

As described above, the acoustic statistic calculation unit 11 calculates an appearance degree for each of a plurality of types of sounds, and calculates an acoustic diversity of a speech signal by using the calculated appearance degrees. In other words, the acoustic statistic calculation unit 11 calculates an acoustic diversity reflecting ratios of the types of sounds included in a speech signal (a ratio of the i-th element distribution to all of the element distributions included in the speech model).

Partial Feature Extraction Unit 13

The partial feature extraction unit 13 receives statistical information (an acoustic diversity, an acoustic feature, and the like) output by the acoustic statistic calculation unit 11. By using the statistical information received, the partial feature extraction unit 13 performs a process of calculating a recognition feature, and outputs the recognition feature calculated. Here, the recognition feature is information for recognizing specific attribute information from a speech signal. The attribute information is information indicating individuality of a speaker who utters the speech signal and indicating a language or the like of the uttered speech signal. The recognition feature is, for example, a vector including one or more values. The recognition feature that is a vector is an i-vector, for example.

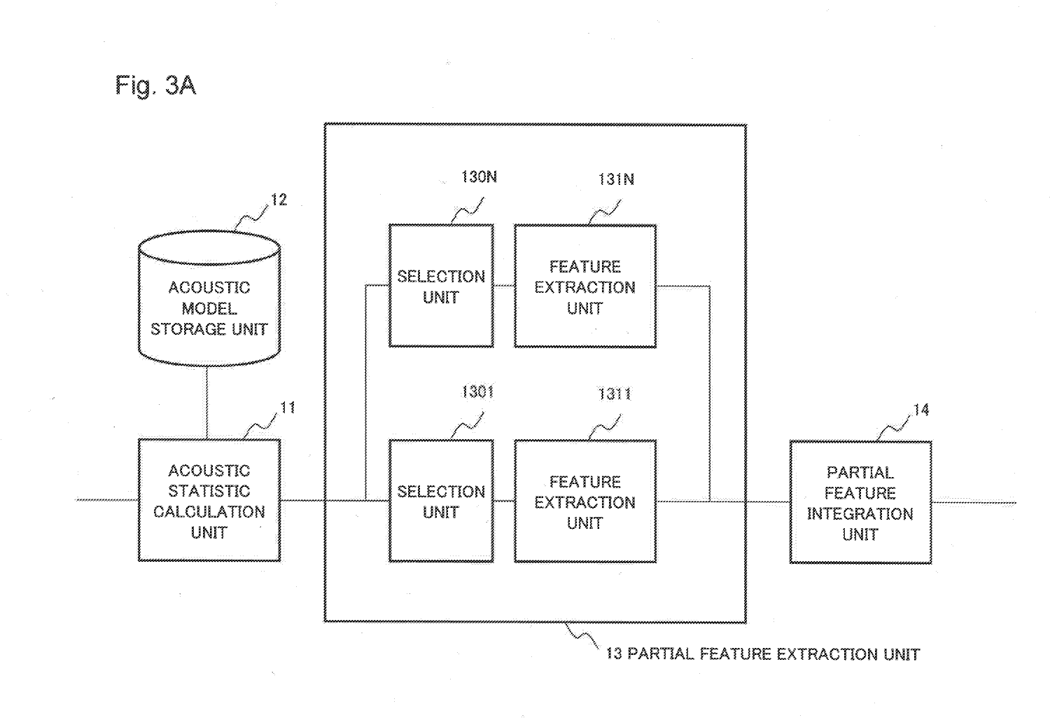

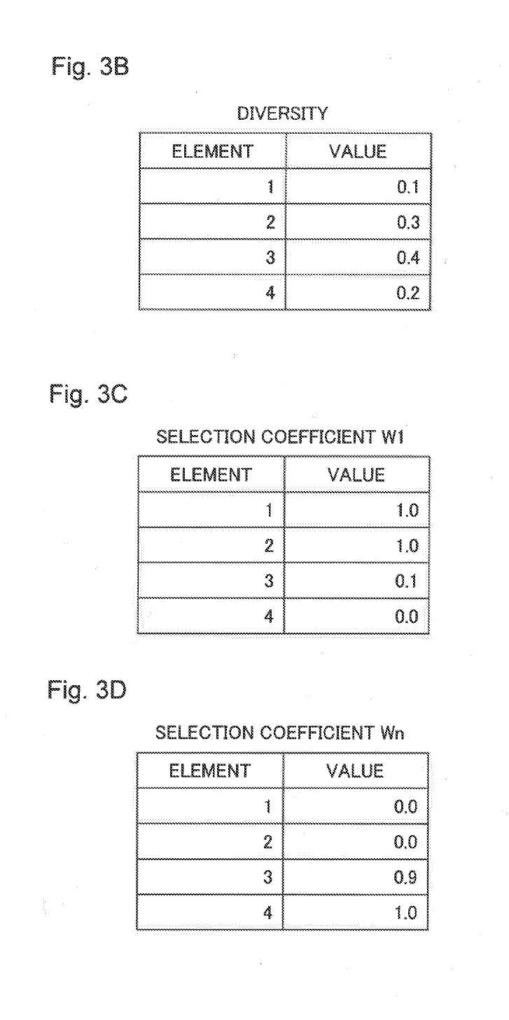

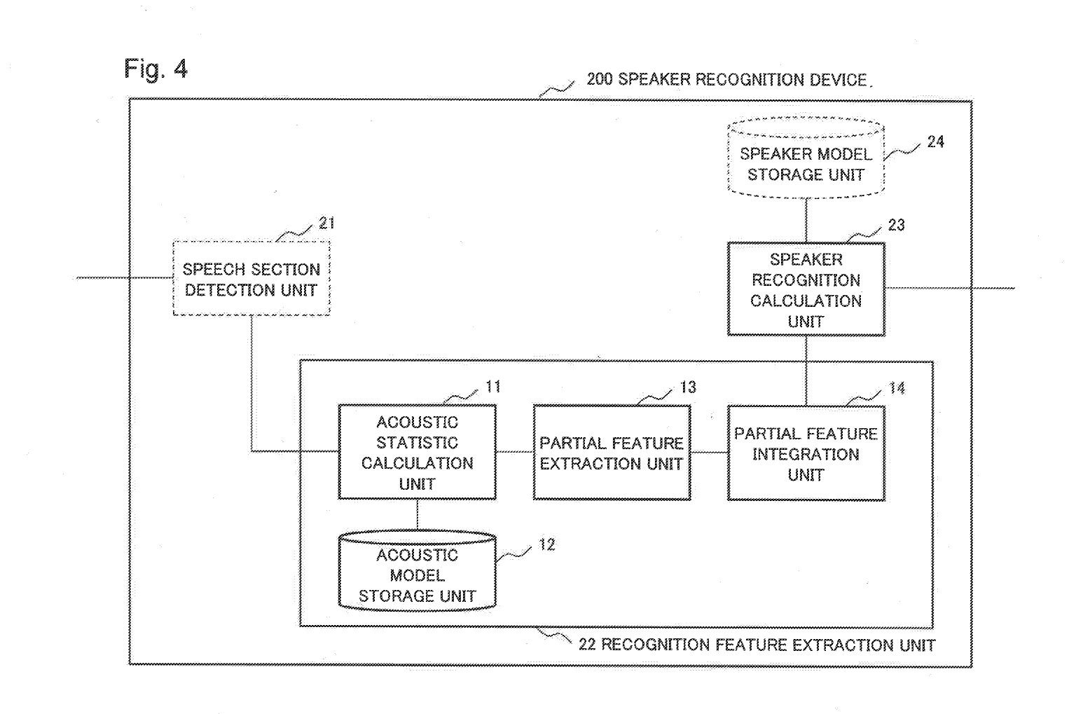

FIG. 3A is a diagram illustrating one example of a configuration of the partial feature extraction unit 13 of the speech processing device 100 according to the present example embodiment. FIG. 3B illustrates an example of an acoustic diversity in the present example embodiment. FIG. 3C illustrates an example of a selection coefficient W1 in the present example embodiment. FIG. 3D illustrates an example of a selection coefficient Wn in the present example embodiment. The selection coefficient is a vector predefined for selecting the type of sounds at the time of feature extraction. In the example of FIG. 3A, the partial feature extraction unit 13 includes a selection unit 130n and a feature extraction unit 131n (n is a natural number equal to or larger than one and equal to or smaller than N, and N is a natural number).

With reference to FIG. 3A, the description is made on one example of a method in which the partial feature extraction unit 13 calculates a recognition feature F(x) of a speech signal x. The recognition feature F(x) may be a vector that can be calculated by performing a predetermined arithmetic operation on the speech signal x. A method in which the partial feature extraction unit 13 calculates, as the recognition feature F(x), a partial feature vector based on an i-vector is described as one example.

For example, from the acoustic statistic calculation unit 11, the partial feature extraction unit 13 receives, as statistical information of a speech signal x, an acoustic diversity Vₜ(x) and an acoustic feature Aₜ(x) (t is a natural number equal to or larger than one and smaller than or equal to T, and T is a natural number) that are calculated for each short time frame. The selection unit 130n of the partial feature extraction unit 13 multiplies each element of the received Vₜ(x) by the selection coefficient Wn determined for each of the selection units, and outputs the result as the weighted acoustic diversity Vₙₜ(x).

By using received Vₙₜ(x) and Aₜ(x), the feature extraction unit 131n of the partial feature extraction unit 13 calculates the zero-order statistic S₀(x) and the first-order statistic S₁(x) of the speech signal x, based on the following equation.

$${S}_{0 , n} ( x ) = ( \begin{matrix}{S}_{0 , n , 1} {I}_{D} & … & {0}_{D} \\ ⋮ & ⋱ & ⋮ \\ {0}_{D} & … & {S}_{0 , n , C} {I}_{D}\end{matrix} ) , \\ {S}_{0 , n , c} = {\sum }_{t = 1}^{T} {V}_{nt , c} ( x ) {I}_{D} \\ {S}_{1 , n} ( x ) = {( {S}_{1 , n , 1} , {S}_{1 , n , 2} , … , {S}_{1 , n , c} )}^{T} , \\ {S}_{1 , n , c} = {\sum }_{t = 1}^{T} {V}_{nt , c} ( x ) ( {A}_{t} ( x ) - {m}_{c} ) \qquad [ Equation 3 ]$$

Here, c is the number of the elements of the statistic S₀(x) or S₁(x), D is the number of the elements (the number of dimensions) of Aₜ(x), m_{c} is a mean vector of the c-th region in an acoustic feature space, I is a unit matrix, and 0 represents a zero matrix.

Subsequently, the feature extraction unit 131n of the partial feature extraction unit 13 calculates a partial feature vector Fₙ(x) that is an i-vector of the speech signal x, based on the following equation.

Fₙ(x)=(1+Tₙ^{T}Σ⁻¹S_{0,n}(x)Tₙ)⁻¹Tₙ^{T}Σ⁻¹S_{1,n}(x) [Equation 4]

Here, Tₙ is a parameter, dependent on the partial feature portion 131n, for calculating an i-vector, and X is a covariance matrix in the acoustic feature space.

The above is the one example of a method in which the partial feature extraction unit 13 calculates, as a recognition feature F(x) to be calculated, a partial feature vector Fₙ(x) based on an i-vector.

When the partial feature extraction unit 13 calculates a partial feature vector Fₙ (n=1, 2, . . . , N; N is a natural number that is one or more) in the above-described procedure, the case where N is one, and each of all the elements of the selection coefficient W1 held by the selection unit 1301 is one is equivalent to the i-vector calculation procedure described in NPL 1. The partial feature extraction unit 13 sets, as a value other than one, each element of the selection coefficient Wn held by the selection unit 130n, and can thereby calculate a feature vector Fₙ(x) different from an i-vector described in NPL 1. Further, the partial feature extraction unit 13 makes setting in such a way that respective elements of the selection coefficient Wn held by the selection unit 130n are different from each other, and thereby, can calculate a plurality of partial feature vectors Fₙ(x) different from an i-vector described in NPL 1.

Next, a setting example of the selection coefficient Wn is described.

For example, when the acoustic model is a neural network configured in such a way as to identify a phoneme, each element of an acoustic diversity V(x) is associated with a phoneme identified by the acoustic model. Accordingly, among the respective elements of the selection coefficient Wn held by the selection unit 130n, only the element, of the acoustic diversity, in association with a certain phoneme is set to be a value different from zero, and the other elements are set to zero. This setting enables the feature extraction unit 131n to calculate a partial feature vector Fₙ(x) that takes only the certain this phoneme into account.

Further, for example, when the acoustic model is a Gaussian mixture model, each element of an acoustic diversity V(x) is associated with an element distribution of the Gaussian mixture model. Accordingly, setting made in such a way that among the respective elements of the selection coefficient Wn held by the selection unit 130n, only the element, of the acoustic diversity, in association with a certain element distribution is a value different from zero, and the other elements are zero enables the feature extraction unit 131n to calculate a partial feature vector Fₙ(x) that takes only this element into account.

Furthermore, for example, when the acoustic model is a GMM, by clustering, for each similarity, a plurality of element distributions included in the acoustic model, the acoustic model can be divided into a plurality of groups (clusters). An example of a clustering method is tree structure clustering. Here, setting made in such a way that among the elements of the selection coefficient Wn held by the selection unit 130n, only the elements in association with elements, of an acoustic diversity, in association with the element distributions included in the first cluster for example are values different from zero, and the other elements are zero enables the feature extraction unit 131n to calculate a partial feature vector Fₙ(x) that takes only the first cluster into account.

The above is the setting example of the selection coefficient Wn.

As described above, the partial feature extraction unit 13 sets the selection coefficient Wn taking the type of sounds into account, multiplies an acoustic diversity V(x) as a statistic of a speech signal x by a selection coefficient Wn taking the type of sounds into account, thereby calculates a weighted acoustic diversity Vₙₜ(x), and calculates a partial feature vector Fₙ(x) by using calculated Vₙₜ(x). Thus, the partial feature extraction unit 13 can output the partial feature vector that takes the type of sounds into account.

Partial Feature Integration Unit 14

The partial feature integration unit 14 receives a recognition feature output by the partial feature extraction unit 13. The partial feature integration unit 14 performs a process of calculating a feature vector by using the received recognition feature, and outputs the processed result. Here, the feature vector is vector information for recognizing a specific attribute information from a speech signal.

The partial feature integration unit 14 receives one or more partial feature vectors Fₙ(x) (n is a natural number equal to or larger than one and equal to or smaller than N; N is a natural number) calculated for the speech signal x by the partial feature extraction unit 13. For example, the partial feature integration unit 14 calculates one feature vector F(x) from the one or more received partial feature vectors Fₙ(x), and outputs the calculated feature vector F(x). For example, the partial feature integration unit 14 calculates a feature vector F(x) as in the following equation 5.

F(x)=(F₁(x)^{T},F₂(x)^{T}, . . . ,F_{N}(x)^{T})^{T} [Equation 5]

Because of the above description, it can be said that the speech processing device 100 according to the present example embodiment performs a process in which a diversity as a degree of variations of types of sounds included in a speech signal is included as parameters by an acoustic diversity calculated by the acoustic statistic calculation unit 11.

Further, by using an acoustic statistic calculated by the acoustic statistic calculation unit 11, the partial feature extraction unit 13 calculates partial feature vectors that take the types of sounds into account, and the partial feature integration unit 14 outputs a feature vector that is integration of these. Thereby, for a speech signal, it is possible to output the feature vector by which association between each element of the feature vector and an element constituting the speech signal can be interpreted. In other words, the speech processing device 100 according to the present example embodiment can calculate a recognition feature suitable for enhancing interpretability of speaker recognition.

Note that the acoustic model storage unit 12 in the speech processing device 100 according to the present example embodiment is preferably a nonvolatile recording medium, but can be implemented even by a volatile recording medium.

A process in which the acoustic model is stored in the acoustic model storage unit 12 is not particularly limited. For example, the acoustic model may be stored in the acoustic model storage unit 12 via a recording medium, or the acoustic model transmitted via a communication line or the like may be stored in the acoustic model storage unit 12. Alternatively, the acoustic model input via an input device may be stored in the acoustic model storage unit 12.

For example, the acoustic statistic calculation unit 11, the partial feature extraction unit 13, and the partial feature integration unit 14 are implemented by hardware such as an arithmetic processing device and a memory taking and executing software that implements these functions. The processing procedures of the acoustic statistic calculation unit 11 and the like are implemented by software, for example, and the software is recorded in a recording medium such as a ROM. Alternatively, each unit of the speech processing device 100 may be implemented by hardware (a dedicated circuit).

### OPERATION OF FIRST EXAMPLE EMBODIMENT

Next, an operation of the speech processing device 100 according to the first example embodiment is described.

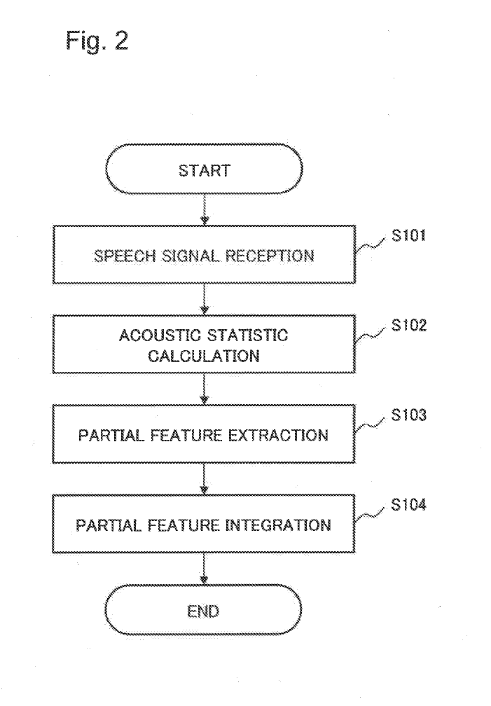

FIG. 2 is a flowchart illustrating one example of the operation of the speech processing device 100 according to the first example embodiment.

The acoustic statistic calculation unit 11 receives one or more speech signals (step S101). Then, for the one or more received speech signals, the acoustic statistic calculation unit 11 refers to the one or more acoustic models stored in the acoustic model storage unit 12, and calculates acoustic statistics including an acoustic diversity (Step S102).

Based on the one or more acoustic statistics calculated by the acoustic statistic calculation unit 11, the partial feature extraction unit 13 calculates and outputs one or more partial recognition feature quantities (step S103).

The partial feature integration unit 14 integrates the one or more partial recognition feature quantities calculated by the partial feature extraction unit 13, and outputs the integrated quantities as a recognition feature (step S104).

When completing output of the recognition feature at the step S104, the speech processing device 100 then ends a series of the processes.

### ADVANTAGEOUS EFFECT OF FIRST EXAMPLE EMBODIMENT

As described above, in the speech processing device 100 according to the present example embodiment, the partial feature extraction unit 13 calculates partial feature vectors taking the types of sounds into account, and the partial feature integration unit 14 integrates the calculated partial feature vectors and thereby outputs a feature vector enabling elements thereof to be associated with constituent elements of a speech signal. In other words, for the speech signal, the speech processing device 100 outputs the feature vector that is integration of the partial feature vectors. By such a calculation method, the speech processing device 100 can calculate a recognition feature (feature vector) for each type of sounds. In other words, interpretability of a speaker recognition result can be improved.

### SECOND EXAMPLE EMBODIMENT

Next, a second example embodiment is described. In the present example embodiment, a speaker recognition device including the speech processing device 100 according to the above-described first example embodiment is described as an application example of the speech processing device. Note that the same reference symbols are attached to constituents having the same functions as those in the first example embodiment, and the description thereof is omitted in some cases.

FIG. 4 is a block diagram illustrating one example of a functional configuration of the speaker recognition device 200 according to the second example embodiment. The speaker recognition device 200 according to the present example embodiment is one example of an attribute recognition device that recognizes specific attribute information from a speech signal. As illustrated in FIG. 4, the speaker recognition device 200 includes at least a recognition feature extraction unit 22 and a speaker recognition calculation unit 23. The speaker recognition device 200 may further include a speech section detection unit 21 and a speaker model storage unit 24.

The speech section detection unit 21 receives a speech signal. Then, the speech section detection unit 21 detects a speech section from the received speech signal, and segments the speech signal. The speech section detection unit 21 outputs a segmented speech signal that is the result of the process of segmenting the speech signal. For example, the speech section detection unit 21 performs the segmenting in such a way as to detect, as a silent speech segment, a section in which sound volume continues to be smaller than a predetermined value for a fixed period of time, in the speech signal, and determine, as different speech sections, the speech sections before and after the detected silent speech section.

Here, “receive a speech signal” means reception of a speech signal from an external device or another processing device, or delivery, of a processed result of a speech signal processing, from another program, for example.

The recognition feature extraction unit 22 receives one or more segmented speech signals output by the speech section detection unit 21, and calculates and outputs a feature vector. When the speaker recognition device 200 does not include the speech section detection unit 21, the recognition feature extraction unit 22 receives a speech signal, and calculates and outputs a feature vector. A configuration and an operation of the recognition feature extraction unit 22 may be identical to the configuration and the operation of the speech processing device 100 according to the first example embodiment. For example, the recognition feature extraction unit 22 may be the speech processing device 100 according to the above-described first example embodiment.

The speaker recognition calculation unit 23 receives a feature vector output by the recognition feature extraction unit 22. Then, the speaker recognition calculation unit 23 refers to the one or more speaker models stored in the speaker model storage unit 24, and calculates a score of speaker recognition that is numerical information representing a degree at which the received recognition feature fits to the speaker model to which the referring has been made. From this score of speaker recognition, attribute information included in the speech signal is specified. Then, further, a speaker, a language, and the like are specified by this specified attribute information. The speaker recognition calculation unit 23 outputs the acquired result (the score of speaker recognition).

The speaker model storage unit 24 stores the one or more speaker models. The speaker model is information for calculating a score of speaker recognition that is a degree at which an input speech signal fits to a specific speaker. For example, the speaker model storage unit 24 stores a speaker model and a speaker identifier (ID) that is an identifier set for each speaker, in such a way as to be associated with each other.

Note that the description is made above for FIG. 4 by citing the example in which the speaker model storage unit 24 is incorporated in the speaker recognition device 200, but there is no limitation to this. The speaker model storage unit 24 may be implemented by a storage device separate from the speaker recognition device 200. The speaker model storage unit 24 may be implemented by a storage device identical to the acoustic model storage unit 12.

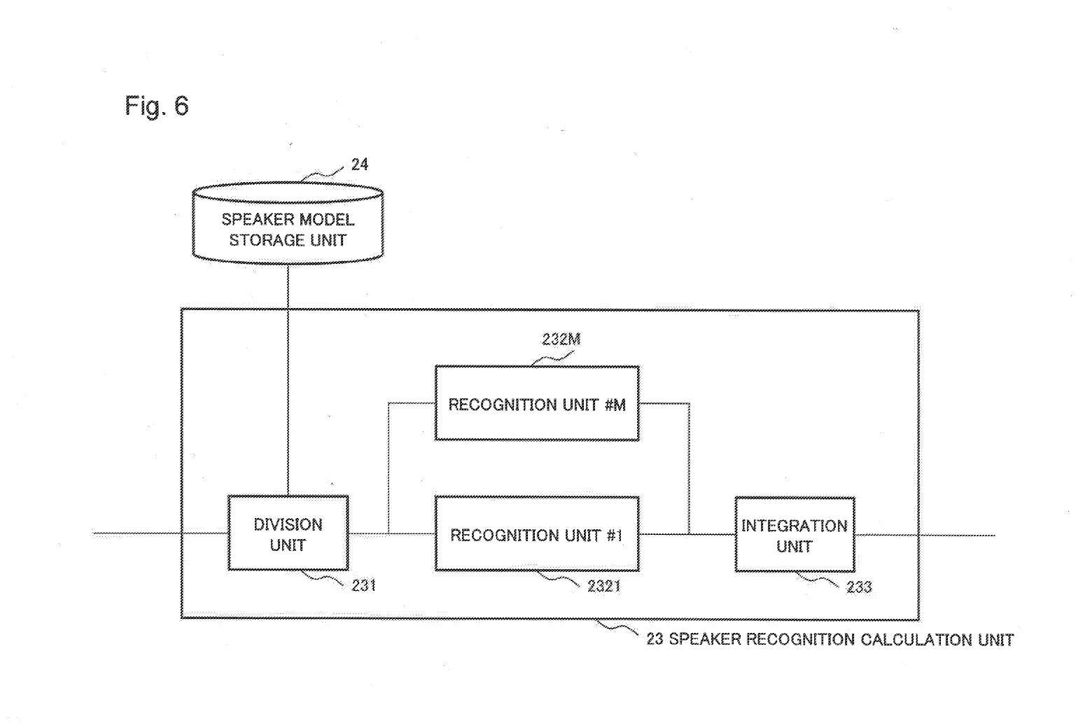

FIG. 6 is a diagram illustrating one example of a configuration of the speaker recognition calculation unit 23 of the speaker recognition device 200 according to the second example embodiment. In the example of FIG. 6, the speaker recognition calculation unit 23 includes a division unit 231, a recognition unit 232m (m=1, 2, . . . , M; M is a natural number that is one or more), and an integration unit 233. The speaker recognition calculation unit 23 calculates a score of speaker recognition by using a feature vector F(x). Further, the speaker recognition calculation unit 23 outputs a speaker recognition result that is information including the calculated score of speaker recognition.

With reference to FIG. 6, the description is made on one example of a method in which the speaker recognition calculation unit 23 calculates a score of speaker recognition by using a feature vector F(x).

The division unit 231 generates a plurality of (M) vectors from a received feature vector F(x). A plurality of the vectors are in association with different types of sounds, respectively. For example, the division unit 231 generates vectors identical to the n partial feature vectors Fₙ(x) calculated by the partial feature extraction unit 13.

The recognition unit 232m receives the m-th vector generated by the division unit 231, and performs speaker recognition calculation. For example, when a recognition feature calculated from a speech signal and the speaker model stored in the speaker model storage unit 24 are each in a vector form, the recognition unit 232m calculates a score, based on a cosine similarity therebetween.

The integration unit 233 integrates scores calculated respectively by a plurality of the recognition units 232m, and outputs the integrated scores as a score of speaker recognition.

The above is one example of the method in which the speaker recognition calculation unit 23 calculates a score of speaker recognition by using a recognition feature F(x) of a speech signal x.

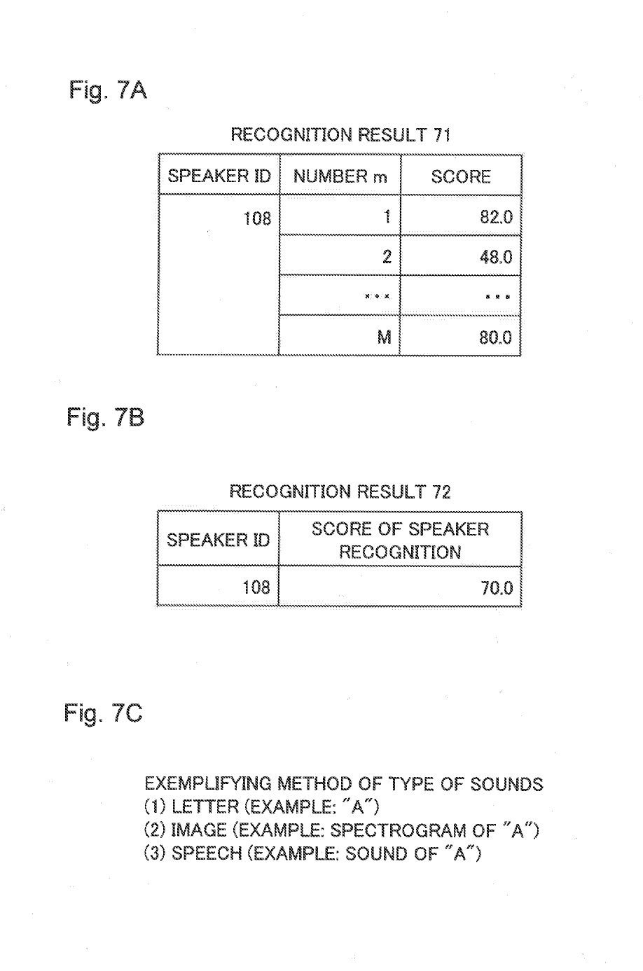

FIG. 7A, FIG. 7B, and FIG. 7C are diagrams illustrating one example of speaker recognition results output by the speaker recognition device 200 according to the present example embodiment.

Speaker recognition results output by the speaker recognition calculation unit 23 are described with reference to FIG. 7A to FIG. 7C.

The integration unit 233 outputs, as information of a speaker recognition result, information in which a speaker ID, the number m of the recognition unit 232m, and a score acquired from the recognition unit 232m are associated with each other as in a recognition result 71 illustrated in FIG. 7A. Here, the integration unit 233 may output information indicating the type of sounds of the number m, in addition to the number m. The integration unit 233 may output, as information indicating the type of sounds, letter information such as a phoneme and words, image information such as a spectrogram, and acoustic information such as a speech signal, for example, as illustrated in FIG. 7C.

Further, the integration unit 233 outputs, as information of a speaker recognition result, information in which a speaker ID and a score of speaker recognition are associated with each other, as in a recognition result 72 illustrated in FIG. 7B. Here, for example, the score of speaker recognition may be calculated by weighted addition of scores acquired from the recognition units 232m. For example, when the speaker recognition device 200 aims to perform speaker verification, the integration unit 233 may output determination information of verification validity based on a score calculated for a verification-target speaker ID. Furthermore, for example, when the speaker recognition device 200 aims to perform speaker identification, the integration unit 233 may output a list of speaker IDs arranged in order of scores calculated for a plurality of speaker IDs. Note that the speaker model storage unit 24 in the speaker recognition device 200 according to the present example embodiment is preferably a nonvolatile recording medium, but can be implemented also by a volatile recording medium.

A process in which the speaker model is stored in the speaker model storage unit 24 is not particularly limited. For example, the speaker model may be stored in the speaker model storage unit 24 via a recording medium, or the speaker model transmitted via a communication line or the like may be stored in the speaker model storage unit 24, or the speaker model input via an input device may be stored in the speaker model storage unit 24.

The speech section detection unit 21, the recognition feature extraction unit 22, and the speaker recognition calculation unit 23 are implemented, for example, by hardware such as a usual arithmetic processing device and a memory taking and executing software that implements these functions. The software may be recorded in a recording medium such as a ROM. Alternatively, each unit of the speaker recognition device 200 may be implemented by hardware (a dedicated circuit).

### OPERATION OF SECOND EXAMPLE EMBODIMENT

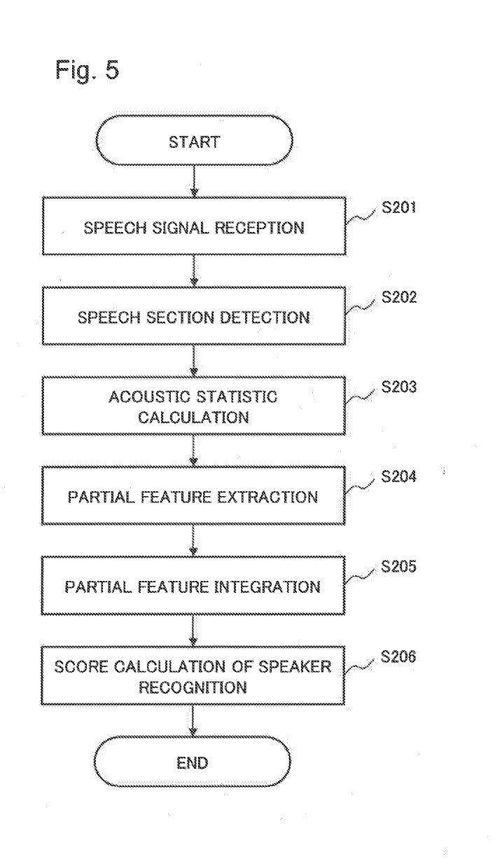

Next, an operation of the speaker recognition device 200 is described with reference to a flowchart of FIG. 5.

FIG. 5 is a flowchart illustrating one example of the operation of the speaker recognition device 200 according to the second example embodiment.

The speech section detection unit 21 receives a speech signal (step S201). Then, the speech section detection unit 21 segments the speech signal by detecting a speech section in the received speech signal. The speech section detection unit 21 outputs one or more segmented speech signals (hereinafter, referred to as segmented speech signals) to the recognition feature extraction unit 22 (step S202).

The recognition feature extraction unit 22 calculates an acoustic statistic for each of the received one or more segmented speech signals (step S203). Then, the recognition feature extraction unit 22 calculates partial recognition feature quantities (partial feature vectors) from the calculated acoustic statistics (step S204), integrates the calculated partial recognition feature quantities (partial feature vectors) and thereby generates a feature vector, and outputs the feature vector (step S205).

For the feature vector calculated by the recognition feature extraction unit 22, the speaker recognition calculation unit 23 refers to one or more speaker models stored in the speaker model storage unit 24, and calculates a score of speaker recognition. The speaker recognition calculation unit 23 outputs the score of speaker recognition (step S206).

When completing the output of the score of speaker recognition at the step S206, the speaker recognition device 200 ends a series of the processes.

### ADVANTAGEOUS EFFECT OF SECOND EXAMPLE EMBODIMENT

As described above, in the speaker recognition device 200, the recognition feature extraction unit 22 calculates partial feature vectors taking the types of sounds into account, integrates the calculated partial feature vectors, and thereby outputs the integrated partial feature vectors as a feature vector by which an element thereof and a speech signal can be associated with each other. Further, the speaker recognition calculation unit 23 calculates a score of speaker recognition from the feature vector, and outputs the calculated score. By such a calculation method, attribute information included in a speech signal can be specified from a score of speaker recognition. A score of speaker recognition for each type of sounds can be calculated. In other words, interpretability of a speaker recognition result can be enhanced.

The speaker recognition device 200 according to the second example embodiment is also one example of an attribute recognition device that recognizes specific attribute information from a speech signal. In other words, it can be said that the speaker recognition device 200 is an attribute recognition device that recognizes, as a specific attribute, information indicating a speaker who utters a speech signal. Further, the speaker recognition device 200 can be applied as a part of a speech recognition device including a mechanism that is adapted to a feature of a speaking manner of a speaker, based on speaker information estimated by the speaker recognition device, for a speech signal of sentence speech utterance, for example. The information indicating the speaker may be information indicating sex of the speaker, and information indicating age or an age range of the speaker. The speaker recognition device 200 can be applied as a language recognition device when recognizing, as a specific attribute, information indicating a language (a language constituting a speech signal) communicated by a speech signal. Furthermore, the speaker recognition device 200 can be applied also as a part of a speech translation device including a mechanism that selects a language to be translated, based on language information estimated by the language recognition device, for a speech signal of sentence speech utterance, for example. The speaker recognition device 200 can be applied as an emotion recognition device when recognizing, as a specific attribute, information indicating emotion at the time of speaking of a speaker.

Further, the speaker recognition device 200 can be applied as a part of a speech search device or a speech display device including a mechanism that specifies a speech signal in association with specific emotion, based on emotion information estimated by the emotion recognition device, for example, for a large number of accumulated speech signals of speech utterance, i.e., can be applied as one type of a speech processing device. For example, this emotion information includes information indicating emotional expression, information indicating character of a speaker, and the like. In other words, the specific attribute information in the present example embodiment is information that represents at least one of a speaker who utters a speech signal, a language constituting a speech signal, emotional expression included in a speech signal, and character of a speaker estimated from a speech signal. The speaker recognition device 200 according to the second example embodiment can recognize such attribute information.

As described above, the speech processing device and the like according to one aspect of the present disclosure achieves an advantageous effect that a feature vector taking the types of sounds into account is extracted from a speech signal, and that interpretability of a speaker recognition result can be enhanced, and is useful as a speech processing device and a speaker recognition device.

It goes without saying that the present disclosure is not limited to the above-described example embodiments, and various modifications can be made within the scope of the invention described in claims, and are also included within the scope of the present disclosure.

A part or all of the above-described example embodiments may be described also as in the following Supplementary Notes, but are not limited to the following.

Supplementary Note 1

A speech processing device including:

an acoustic model storage unit that stores one or more acoustic models;

an acoustic statistic calculation unit that calculates an acoustic feature from a received speech signal, and by using the acoustic feature calculated and the acoustic model stored, calculates an acoustic diversity that is a vector representing a degree of variations of types of sounds;

a partial feature extraction unit that, by using the calculated acoustic diversity and a selection coefficient, calculates a weighted acoustic diversity, and by using the weighted acoustic diversity calculated and the acoustic feature, calculates a recognition feature for recognizing individuality or a language of a speaker;

a partial feature integration unit that calculates a feature vector by using the recognition feature calculated; and

a speaker recognition calculation unit that calculates, from the calculated feature vector, a score of speaker recognition that is a degree at which the speech signal fits to a specific speaker.

Supplementary Note 2

The speech processing device according to Supplementary Note 1, wherein the partial feature extraction unit calculates a plurality of weighted acoustic diversities from the acoustic diversity, and calculates a plurality of recognition feature quantities from the respective weighted acoustic diversities and the acoustic feature.

Supplementary Note 3

The speech processing device according to Supplementary Note 1 or 2, wherein the partial feature extraction unit calculates, as the recognition feature, a partial feature vector expressed in a vector form.

Supplementary Note 4

The speech processing device according to any one of Supplementary Notes 1 to 3, wherein by using the acoustic model, the acoustic statistic calculation unit calculates the acoustic diversity, based on ratios of types of sounds included in the received speech signal.

Supplementary Note 5

The speech processing device according to any one of Supplementary Notes 1 to 4, wherein, by using a Gaussian mixture model as the acoustic model, the acoustic statistic calculation unit calculates the acoustic diversity, based on a value calculated as a posterior probability of an element distribution.

Supplementary Note 6

The speech processing device according to any one of Supplementary Notes 1 to 4, wherein, by using a neural network as the acoustic model, the acoustic statistic calculation means calculates the acoustic diversity, based on a value calculated as an appearance degree of a type of sounds.

Supplementary Note 7

The speech processing device according to any one of Supplementary Notes 1 to 3, wherein the partial feature extraction means calculates an i-vector as the recognition feature by using the acoustic diversity of the speech signal, a selection coefficient, and the acoustic feature.

Supplementary Note 8

The speech processing device according to any one of Supplementary Notes 1 to 7, further including a speaker recognition calculation unit that calculates, from the calculated feature vector, a score of speaker recognition that is a degree at which the speech signal fits to a specific speaker.

Supplementary Note 9

A speech processing device including:

a speech section detection unit that segments a received speech signal into a segmented speech signal;

an acoustic model storage unit that stores one or more acoustic models;

an acoustic statistic calculation unit that calculates an acoustic feature from the segmented speech signal, and by using the acoustic feature calculated and the acoustic model stored in the acoustic model storage unit, calculates an acoustic diversity that is a vector representing a degree of variations of types of sounds;

a partial feature extraction unit that, by using the calculated acoustic diversity and a selection coefficient, calculates a weighted acoustic diversity, and by using the weighted acoustic diversity calculated and the acoustic feature, calculates a recognition feature for recognizing individuality or a language of a speaker;

a partial feature integration unit that calculates a feature vector by using the recognition feature calculated; and

a speaker recognition calculation unit that calculates, from the calculated feature vector, a score of speaker recognition that is a degree at which the speech signal fits to a specific speaker.

Supplementary Note 10

The speech processing device according to Supplementary Note 9, wherein the speaker recognition calculation unit generates, from the feature vector, a plurality of vectors respectively in association with different types of sounds, calculates scores respectively for the plurality of vectors, and integrates a plurality of the calculated scores and thereby calculates a score of speaker recognition.

Supplementary Note 11

The speech processing device according to Supplementary Note 10, wherein the speaker recognition calculation unit outputs the calculated score in addition to information indicating a type of sounds.

Supplementary Note 12

The speech processing device according to any one of Supplementary Notes 1 to 11, wherein the feature vector is information for recognizing at least one of a speaker who utters the speech signal, a language constituting the speech signal, emotional expression included in the speech signal, and a character of a speaker estimated from the speech signal.

Supplementary Note 13

A speech processing method including:

storing one or more acoustic models;

calculating an acoustic feature from a received speech signal, and by using the acoustic feature calculated and the acoustic model stored, calculating an acoustic diversity that is a vector representing a degree of variations of types of sounds;

by using the calculated acoustic diversity and a selection coefficient, calculating a weighted acoustic diversity;

by using the weighted acoustic diversity calculated and the acoustic feature, calculating a recognition feature that is information for recognizing information indicating individuality, a language, or the like of a speaker; and

calculating a feature vector by using the recognition feature calculated.

Supplementary Note 14

A program for causing a computer to function as:

a means for storing one or more acoustic models;

a means for calculating an acoustic feature from a received speech signal, and by using the acoustic feature calculated and the acoustic model stored, calculating an acoustic diversity that is a vector representing a degree of variations of types of sounds; and

a means for, by using the acoustic diversity calculated and a selection coefficient, calculating a weighted acoustic diversity, and by using the weighted acoustic diversity calculated and the acoustic feature, calculating a recognition feature that is information for recognizing information indicating individuality, a language, or the like of a speaker.

### REFERENCE SIGNS LIST

11 Acoustic statistic calculation unit
12 Acoustic model storage unit
13 Partial feature extraction unit
130n Selection unit
131n Feature extraction unit
14 Partial feature integration unit
21 Speech section detection unit
22 Recognition feature extraction unit
23 Speaker recognition calculation unit
231 Division unit
232m Recognition unit
233 Integration unit
24 Speaker model storage unit
100 Speech processing device
200 Speaker recognition device
V(x) Acoustic diversity of speech signal x
Vₜ(x) Acoustic diversity calculated for each short time frame
Vₙₜ(x) Weighted acoustic diversity
Pᵢ(x) Posteriori probability of i-th element distribution of GMM
N( ) Probability density function of Gaussian distribution
θᵢ Parameter (mean and variance) of i-th element distribution of GMM
wᵢ Mixing coefficient of i-th element distribution of GMM
Cᵢ(x) Number of times i-th element distribution of GMM is selected
Wn Selection coefficient
F(x) Recognition feature
Fₙ(x) Partial feature vector
S₀(x) Zero-order statistic of speech signal x
S₁(x) First-order statistic of speech signal x
Aₜ(x) Acoustic feature
c Number of elements of statistics S₀(x) and S₁(x)
D Number of elements of Aₜ(x) (number of dimensions)
m_{c} Mean vector of c-th region in acoustic feature space
S₁(x) First-order statistic of speech signal x

1. A speech processing device comprising:
at least one memory configured to store instructions and;
at least one processor configured to execute the instructions to:
store one or more acoustic models;
calculate an acoustic feature from a received speech signal, and by using the acoustic feature calculated and the acoustic model stored, calculate an acoustic diversity that is a vector representing a degree of variations of types of sounds;
by using the calculated acoustic diversity and a selection coefficient, calculate a weighted acoustic diversity, and by using the weighted acoustic diversity calculated and the acoustic feature, calculate a recognition feature for recognizing identity of a speaker that concerns the speech signal; and
calculate a feature vector by using the recognition feature calculated.

2. The speech processing device according to claim 1, wherein the at least one processor configured to execute the instructions to calculate a plurality of the weighted acoustic diversities from the acoustic diversity, and calculate a plurality of the recognition feature quantities from the plurality of respective weighted acoustic diversities and the acoustic feature.

3. The speech processing device according to claim 1, wherein the at least one processor configured to execute the instructions to calculate, as the recognition feature, a partial feature vector expressed in a vector form.

4. The speech processing device according to claim 1, wherein the at least one processor configured to execute the instructions to, by using the acoustic model, calculate the acoustic diversity, based on ratios of types of sounds included in the received speech signal.

5. The speech processing device according to claim 1, the at least one processor further configured to execute the instructions to calculate from the calculated feature vector, a score of speaker recognition that is a degree at which the speech signal fits to a specific speaker.

6. The speech processing device according to claim 5, wherein the at least one processor configured to execute the instructions to generate from the feature vector, a plurality of vectors respectively in association with different types of sounds, calculate scores respectively for the plurality of vectors, and integrate a plurality of the calculated scores and thereby calculate a score of speaker recognition.

7. The speech processing device according to claim 6, wherein the at least one processor configured to execute the instructions to output the calculated score in addition to information indicating a type of sounds.

8. The speech processing device according to claim 1, wherein the feature vector is information for recognizing at least one of a language constituting the speech signal, emotional expression included in the speech signal, and a character of a speaker estimated from the speech signal.

9. A speech processing method comprising:
storing one or more acoustic models;
calculating an acoustic feature from a received speech signal, and by using the acoustic feature calculated and the acoustic model stored, calculating an acoustic diversity that is a vector representing a degree of variations of types of sounds;
by using the calculated acoustic diversity and a selection coefficient, calculating a weighted acoustic diversity;
by using the weighted acoustic diversity calculated and the acoustic feature, calculating a recognition feature for recognizing identity of a speaker; and
calculating a feature vector by using the recognition feature calculated.

10. A non-transitory computer-readable recording medium that stores a program for causing a computer to execute to a speech processing method comprising:
storing one or more acoustic models;
calculating an acoustic feature from a received speech signal, and by using the acoustic feature calculated and the acoustic model stored, calculating an acoustic diversity that is a vector representing a degree of variations of types of sounds; and
by using the calculated acoustic diversity and a selection coefficient, calculating a weighted acoustic diversity, and by using the weighted acoustic diversity calculated and the acoustic feature, calculating a recognition feature for recognizing identity of a speaker.

11. The speech processing device according to claim 1, wherein the at least one processor configured to execute the instructions to, by using a Gaussian mixture model as the acoustic model, calculate the acoustic diversity, based on a value calculated as a posterior probability of an element distribution.

12. The speech processing device according to claim 1, wherein the at least one processor configured to execute the instructions to, by using a neural network as the acoustic model, calculate the acoustic diversity, based on a value calculated as an appearance degree of a type of sounds.

13. The speech processing device according to claim 1, wherein the at least one processor configured to execute the instructions to calculate an i-vector as the recognition feature by using the acoustic diversity of the speech signal, a selection coefficient, and the acoustic feature.

14. The speech processing device according to claim 5, wherein the at least one processor further configured to
execute the instructions to segment a received speech signal into a segmented speech signal; and
calculate an acoustic feature from the segmented speech signal, and calculate an acoustic diversity that is a vector representing a degree of variations of types of sounds, by using the acoustic feature calculated and the acoustic model stored.
